(19) United States
(12) Patent Application Publication
(10) Pub. No.: US 2025/0291883 A1
(43) Pub. Date: Sep. 18, 2025

(54) VEHICLE AND AUTHENTICATION METHOD

(71) Applicant: Panasonic Automotive Systems Co., Ltd., Kanagawa (JP)

(72) Inventors: Takumaru NAGAI, Osaka (JP); Kaoru YOKOTA, Hyogo (JP); Tomohisa SEZAKI, Kanagawa (JP); Akihito TAKEUCHI, Osaka (JP)

(73) Assignee: Panasonic Automotive Systems Co., Ltd., Kanagawa (JP)

(21) Appl. No.: 19/072,363

(22) Filed: Mar. 6, 2025

(30) Foreign Application Priority Data
Mar. 12, 2024 (JP) 2024-038117

(51) Int. Cl. G06F 21/10; G06F 21/12

(52) U.S. Cl. CPC G06F 21/1077; G06F 21/121

(57) ABSTRACT

A vehicle is communicatively connected to a server via a network, and includes: a first acquirer that acquires user information for identifying a user; a storage that stores vehicle information for identifying the vehicle; a transmitter that transmits the user information acquired and the vehicle information stored in the storage to the server; a second acquirer that acquires, from the server, function information indicating one or more functions that are identified based on the user information and the vehicle information, are performable by the vehicle, and are permitted to be utilized by the user; and a controller that enables the one or more functions indicated by the function information.

### CROSS REFERENCE TO RELATED APPLICATION

The present application is based on and claims priority of Japanese Patent Application No. 2024-038117 filed on Mar. 12, 2024.

### FIELD

The present disclosure relates to vehicles and authentication methods.

### BACKGROUND

Patent Literature (PTL) 1 discloses a service management system which can manage, for each user, details of services provided to users of vehicles.

### CITATION LIST

### Patent Literature

PTL 1: Japanese Unexamined Patent Application Publication No. 2019-109816

### SUMMARY

However, the system according to PTL 1 can be improved upon.

In view of this, the present disclosure provides a device capable of improving upon the above related art.

A vehicle according to an aspect of the present disclosure is a vehicle that is communicatively connected to a server via a network, and includes: a first acquirer that acquires user information for identifying a user; a storage that stores vehicle information for identifying the vehicle; a transmitter that transmits the user information acquired and the vehicle information stored in the storage to the server; a second acquirer that acquires, from the server, function information indicating one or more functions that are identified based on the user information and the vehicle information, are performable by the vehicle, and are permitted to be utilized by the user; and a controller that enables the one or more functions indicated by the function information.

An authentication method according to an aspect of the present disclosure is an authentication method performed by an authentication system including a server and a vehicle that is communicatively connected to the server via a network, and the authentication method includes: acquiring, by the vehicle, user information for identifying a user; acquiring, by the vehicle, vehicle information for identifying the vehicle; transmitting, by the vehicle, the user information acquired and the vehicle information acquired to the server; acquiring, by the vehicle, from the server, function information indicating one or more functions that: are identified based on the user information and the vehicle information; are performable by the vehicle; and are permitted to be utilized by the user; and enabling, by the vehicle, the one or more functions indicated by the function information.

These general or specific aspects may be realized by a device, an integrated circuit, a computer program, or a non-transitory computer-readable recording medium such as a CD-ROM, or may be realized by any combination of a device, an integrated circuit, a computer program, and a non-transitory recording medium.

A vehicle and the like according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram for illustrating an outline of an authentication system in Embodiment 1.

FIG. 2 is a hardware configuration diagram of a server in Embodiment 1.

FIG. 3 is a hardware configuration diagram of a vehicle according to Embodiment 1.

FIG. 4 is a hardware configuration diagram of an information terminal in Embodiment 1.

FIG. 5 is a diagram showing an example of the functional configuration of the authentication system in Embodiment 1.

FIG. 6 is a diagram for illustrating registration processing for user information.

FIG. 7 is a sequence diagram showing an example of an authentication method performed by the authentication system in Embodiment 1.

FIG. 8 is a diagram for illustrating the flow of information in processing in the authentication method.

FIG. 9 is a diagram for illustrating the flow of information in the processing in the authentication method.

FIG. 10 is a diagram for illustrating the flow of information in the processing in the authentication method.

FIG. 11 is a diagram for illustrating the flow of information in the processing in the authentication method.

FIG. 12 is a diagram for illustrating an outline of an authentication system in Embodiment 2.

FIG. 13 is a diagram showing an example of the functional configuration of the authentication system in Embodiment 2.

FIG. 14 is a diagram for illustrating registration processing for user information.

FIG. 15 is a sequence diagram showing an example of an authentication method performed by the authentication system in Embodiment 2.

FIG. 16 is a diagram for illustrating the flow of information in processing in the authentication method.

FIG. 17 is a diagram for illustrating the flow of information in the processing in the authentication method.

FIG. 18 is a diagram for illustrating the flow of information in the processing in the authentication method.

### DESCRIPTION OF EMBODIMENTS

### Underlying Knowledge Forming Basis of the Present Disclosure

A vehicle such as a software defined vehicle (SDV) is known which can update functions by updating, or can update functions by installing applications developed by third parties. In the vehicle which can update functions as described above, user convenience is enhanced, but the number of entry points for attacks is increased to facilitate attacks, with the result that security risks are increased.

It is likely that a user makes a payment to a software provider, and thus the updating of a function as described above is additionally performed on a default function. In such a case, the function of the vehicle which has been updated as a result of the user making a payment is managed to be associated not with the user but with the vehicle which is the target for the updating of the function.

Incidentally, in recent years, the number of users who utilize car sharing services and the like has been increasing. Such users often utilize different vehicles. In the mechanism for updating the function described above, the function of the vehicle which has been updated is permitted to be utilized only in the vehicle which is the target for the updating of the function. Hence, a user who often utilizes different vehicles cannot utilize the additional function without making a payment for each of the vehicles. In the mechanism for updating the function described above, since the function of the vehicle which has been updated is maintained as it is, in the form of a car sharing service where one vehicle is utilized by different users one after another, a function which has been added as a result of a certain user making a payment can be utilized by a user who thereafter utilizes the vehicle without making a payment.

In order to solve the issue described above, the present inventors have found a vehicle and the like in which only a user who makes a payment can utilize an additional function regardless of the vehicle.

A vehicle according to a first aspect of the present disclosure is a vehicle that is communicatively connected to a server via a network, the vehicle includes: a processor; and a non-transitory memory that stores a program, and the processor executes the program to cause the vehicle to operate as: a first acquirer that acquires user information for identifying a user; a storage that stores vehicle information for identifying the vehicle; a transmitter that transmits the user information acquired and the vehicle information stored in the storage to the server; a second acquirer that acquires, from the server, function information indicating one or more functions that: are identified based on the user information and the vehicle information; are performable by the vehicle; and are permitted to be utilized by the user; and a controller that enables the one or more functions indicated by the function information.

In this way, since the function information indicating the one or more functions that are identified based on the user information and the vehicle information, are performable by the vehicle, and are permitted to be utilized by the user is enabled, only the user who has made a payment can utilize an additional function regardless of the vehicle.

A vehicle according to a second aspect of the present disclosure is the vehicle according to the first aspect, the first acquirer repeatedly acquires the user information from a circuit that holds the user information by wirelessly communicating with the circuit, and when the first acquirer acquires information different from the user information acquired at a previous timing, the controller disables the one or more functions.

In this way, when user information different from the user information acquired at the previous timing is acquired, the one or more functions which have been enabled based on the user information acquired at the previous timing can be disabled. Hence, it is possible to suppress a disadvantage in which a function that a certain user can add by making a payment can be utilized by the user who utilizes the vehicle thereafter without making a payment.

A vehicle according to a third aspect of the present disclosure is the vehicle according to the second aspect, and when the first acquirer acquires the same information as the user information acquired at the previous timing, the controller keeps the one or more functions enabled.

In this way, when the same user information as the user information acquired at the previous timing is acquired, since the one or more functions are kept enabled, the user can continuously utilize the one or more functions.

An authentication method according to a fourth aspect of the present disclosure is an authentication method performed by an authentication system including a server and a vehicle that is communicatively connected to the server via a network, and the authentication method includes: acquiring, by the vehicle, user information for identifying a user; acquiring, by the vehicle, vehicle information for identifying the vehicle; transmitting, by the vehicle, the user information acquired and the vehicle information acquired to the server; acquiring, by the vehicle, from the server, function information indicating one or more functions that: are identified based on the user information and the vehicle information; are performable by the vehicle; and are permitted to be utilized by the user; and enabling, by the vehicle, the one or more functions indicated by the function information.

In this way, since the function information indicating the one or more functions that are identified based on the user information and the vehicle information, are performable by the vehicle, and are permitted to be utilized by the user is enabled, only the user who has made a payment can utilize an additional function regardless of the vehicle.

An authentication method according to a fifth aspect of the present disclosure is the authentication method according to the fourth aspect, and the authentication method includes: acquiring, by the server, the user information and the vehicle information from the vehicle; identifying, by the server, the one or more functions based on the user information, the vehicle information, and permission information that is previously stored; and transmitting, by the server, to the vehicle, the function information indicating the one or more functions identified.

Hence, it is possible to appropriately identify the one or more functions which can be utilized by the user.

An authentication method according to a sixth aspect of the present disclosure is the authentication method according to the fifth aspect, the permission information includes: one or more permission functions that are permitted to be utilized by the user identified by the user information; and one or more performable functions that are performable by the vehicle identified by the vehicle information, and in the identifying, the server identifies, as the one or more functions, one or more common functions that are common to the one or more permission functions and the one or more performable functions.

Hence, it is possible to appropriately identify the one or more functions which are performable by the vehicle and are permitted to be utilized by the user.

An authentication method according to a seventh aspect of the present disclosure is the authentication method according to any one of the fourth to sixth aspects, and the authentication method includes: transitioning to a state where an operation of the vehicle is performable, by receiving, by the vehicle, operation permission information for permitting the operation; transmitting, by the server, to an information terminal possessed by the user, inquiry information for inquiring whether to permit the user identified by the user information to utilize the vehicle identified by the vehicle information when the user information and the vehicle information are acquired from the vehicle; acquiring, by the server, from the information terminal, response information indicating a response to the inquiry information; and preventing, by the server, transmission of the operation permission information when the response information indicates that the vehicle is not permitted to be utilized.

Hence, user authentication for the utilization of the vehicle performed by the user can be performed by the information terminal.

An authentication method according to an eighth aspect of the present disclosure is the authentication method according to any one of the fourth to sixth aspects, and the authentication method includes: transitioning to a state where an operation of the vehicle is performable, by receiving, by the vehicle, operation permission information for permitting the vehicle to perform the operation; transmitting, by the server, to the other server, inquiry information for inquiring whether the user identified by the user information is previously permitted to utilize the vehicle identified by the vehicle information when the user information and the vehicle information are acquired from the vehicle; receiving, by the server, from the other server, response information indicating a response to the inquiry information; and preventing, by the server, transmission of the operation permission information to the vehicle when the response information indicates that the vehicle is not permitted to be utilized.

Hence, user authentication for the utilization of the vehicle performed by the user can be performed by the other server.

These general or specific aspects may be realized by a device, an integrated circuit, a computer program, or a non-transitory computer-readable recording medium such as a CD-ROM, or may be realized by any combination of a device, a method, a system, an integrated circuit, a computer program, and a non-transitory recording medium.

Embodiments will be described in detail below with reference to drawings as necessary. However, a detailed description beyond necessity may be omitted. For example, a detailed description of an already well known matter or a repeated description of substantially the same configuration may be omitted. This is intended for preventing the following description from being unnecessarily redundant and facilitating the understanding of a person skilled in the art.

The inventor provides accompanying drawings and the following description so that the person skilled in the art fully understands the present disclosure, and they do not intend to limit the scope of claims.

### Embodiment 1

### Configuration

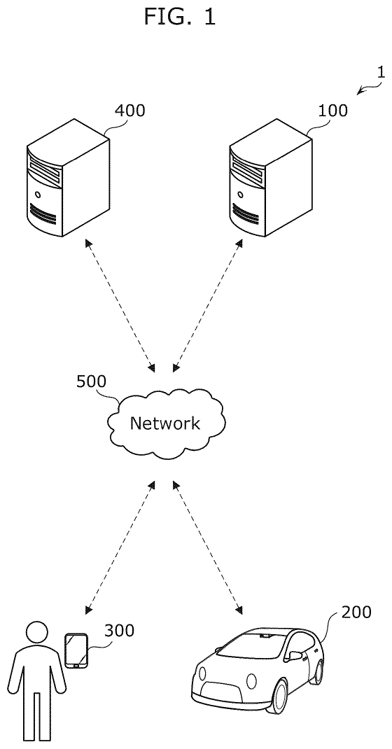

FIG. 1 is a diagram for illustrating an outline of an authentication system in Embodiment 1.

Specifically, FIG. 1 shows servers 100 and 400, vehicle 200, information terminal 300, and network 500. For example, authentication system 1 includes, among these constituent elements, servers 100 and 400, vehicle 200, and information terminal 300. Server 100 is a server for managing the functions of vehicle 200 which can be utilized by a user. Server 400 is a server for providing a car sharing service. Vehicle 200 is, for example, a vehicle which is rented to the user in the car sharing service. Information terminal 300 is a terminal which is possessed by the user.

Servers 100 and 400, vehicle 200, and information terminal 300 are communicatively connected via network 500. Information terminal 300 may be communicatively connected to network 500 via an unillustrated wireless LAN router, or may be communicatively connected to network 500 by communicating with a base station on a mobile phone communication line.

Authentication system 1 is a system which manages an additional function that the user can utilize by making a payment, and permits only the user who has made a payment to utilize the additional function regardless of the vehicle.

In authentication system 1, server 100 associates one or more permission functions which are functions of the vehicle that are permitted to be utilized by the user with user information for identifying the user, and stores them. The one or more permission functions include an additional function which the user can utilize by making a payment. Examples of the additional function include: a function for changing the seat layout of vehicle 200; a function for enhancing the acceleration performance of an engine; a function related to a car navigation system; a function related to entertainment such as music and video to be played in the interior of the vehicle; and the like. Vehicle 200 includes, in addition to the additional function, functions which the user can utilize without making a payment. Examples of the functions which the user can utilize without making a payment include: functions related to basic driving of vehicle 200; functions related to control of the body of vehicle 200 such as opening and closing of doors and windows; and the like. Server 100 associates vehicle information for identifying the vehicle with one or more performable functions which are performable by the vehicle, and stores them.

Server 400 stores information for managing the schedule of the vehicle utilized by the user. For example, server 400 associates the user information for identifying the user, the vehicle information for identifying the vehicle which is scheduled to be utilized by the user, and period information indicating a period during which the user utilizes the vehicle with each other, and stores them. The user information managed by server 400 includes destination information for transmitting information to information terminal 300 possessed by the user.

The user information stored in server 100 may be the same as or different from the user information stored in server 400. When these pieces of user information are different from each other, association may be performed using common information included in these pieces of user information. The common information is information specific to the user for identifying the user, and examples thereof include the name of the user, the date of birth, an address, a telephone number, user identification information given to the user, and the like.

The user information managed by servers 100 and 400 may include destination information for transmitting information to information terminal 300 possessed by the user identified by the user information. The vehicle information managed by servers 100 and 400 may include destination information for transmitting information to vehicle 200 identified by the vehicle information.

Servers 100 and 400 manage the information as described above to be able to associate the user or information terminal 300 possessed by the user with vehicle 200 utilized by the user. Servers 100 and 400 can transmit information for the user to information terminal 300 or vehicle 200.

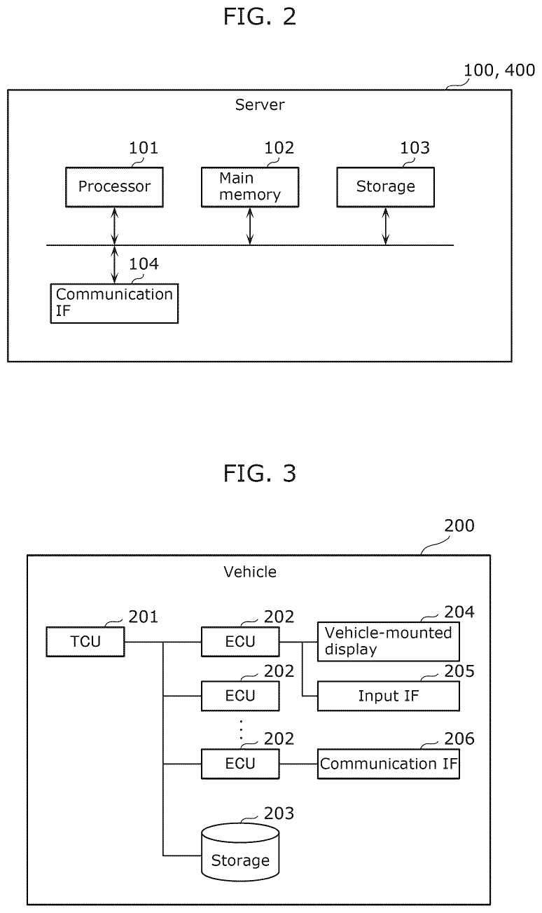

FIG. 2 is a hardware configuration diagram of the server in Embodiment 1.

As shown in FIG. 2, each of servers 100 and 400 includes, as a hardware configuration, processor 101, main memory 102, storage 103, and communication interface IF 104.

Processor 101 is a processor which executes programs stored in storage 103 and the like.

Main memory 102 is a volatile storage region which is used to temporarily store data generated during processing executed by processor 101, is used as a work area used when processor 101 executes programs, or is used to temporarily store data received by communication IF 104.

Storage 103 is a nonvolatile storage region which holds various types of data such as programs. Storage 103 stores, for example, various types of data generated as a result of processing executed by processor 101 and various types of data received by communication IF 104.

Communication IF 104 is a communication interface for exchanging information between vehicle 200, information terminal 300, and the other server via network 500. Communication IF 104 may be, for example, an interface for wireless communication such as a wireless LAN interface or a Bluetooth (registered trademark) interface. Communication IF 104 may be an interface for wired communication such as a universal serial bus (USB) or a wired LAN interface.

FIG. 3 is a block diagram showing an example of the hardware configuration of the vehicle according to Embodiment 1.

As shown in FIG. 3, vehicle 200 includes, as a hardware configuration, telematics control unit (TCU) 201, a plurality of ECUs 202, storage 203, vehicle-mounted display 204, input interface (IF) 205, and communication interface (IF) 206.

TCU 201 is a communication unit with which vehicle 200 wirelessly communicates with network 500. TCU 201 is a communication unit which includes a cellular module that complies with the standards of a mobile communication network.

ECUs 202 include control circuits which acquire information from TCU 201, acquire the results of detection from various types of sensors, and perform processing corresponding to the information and the results of detection that have been acquired. For example, at least one of ECUs 202 are control circuits which acquire the results of detection from various types of sensors, and use the acquired results of detection to control autonomous driving of vehicle 200. ECUs 202 also include a control circuit which controls vehicle-mounted display 204 included in vehicle 200 or other devices included in vehicle 200. Here, examples of the other devices include an engine, a motor, a meter, a transmission, a brake, steering, power windows, an air conditioner, and the like. ECUs 202 may be provided according to the various types of devices described above. Each of ECUs 202 may include a storage (nonvolatile storage region) which stores programs to be executed by ECU 202 though the storage is not illustrated here. The storage is, for example, a nonvolatile memory.

Storage 203 is a nonvolatile storage region which holds a control program and the like. Storage 203 is realized by, for example, a hard disk drive (HDD), a solid state drive (SSD), or the like.

Vehicle-mounted display 204 is disposed in the interior of vehicle 200, and displays information indicated by characters or symbols to the user in the interior of the vehicle. Vehicle-mounted display 204 may display an image. Vehicle-mounted display 204 is a liquid crystal display, an organic EL display, or the like.

Input IF 205 is disposed in the interior of vehicle 200, and receives an input (operation) from the user in the interior of the vehicle. For example, input IF 205 may be a touch panel which is disposed on the surface of vehicle-mounted display 204, or may be a touch pad which is disposed within the reach of the user seated in a seat of vehicle 200

Communication IF 206 is a communication interface for receiving the user information from a circuit which holds the user information. Communication IF 206 may be, for example, an interface for wireless communication such as a Bluetooth (registered trademark) interface or an NFC interface.

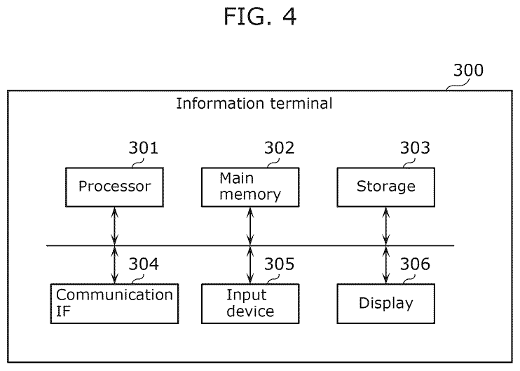

FIG. 4 is a hardware configuration diagram of the information terminal in Embodiment 1.

As shown in FIG. 4, information terminal 300 includes, as a hardware configuration, processor 301, main memory 302, storage 303, communication interface (IF) 304, input device 305, and display 306.

Processor 301 is a processor which executes programs stored in storage 303 and the like.

Main memory 302 is a volatile storage region which is used to temporarily store data generated during processing executed by processor 301, is used as a work area used when processor 301 executes programs, or is used to temporarily store data received by communication IF 304.

Storage 303 is a nonvolatile storage region which holds various types of data such as programs. Storage 303 stores, for example, various types of data generated as a result of processing executed by processor 301 and various types of data received by communication IF 304.

Communication IF 304 is a communication interface for exchanging information between servers 100 and 400 and vehicle 200 via network 500. Communication IF 304 may be, for example, an interface for wireless communication such as a wireless LAN interface or a Bluetooth (registered trademark) interface. Communication IF 304 may be an interface for wired communication such as a universal serial bus (USB) or a wired LAN interface.

Input device 305 is an interface for receiving an input from a person. Input device 305 may be a pointing device such as a mouse, a touch pad, a touch panel, or a trackball, or may be a keyboard.

Display 306 is a liquid crystal display, an organic EL display, or the like.

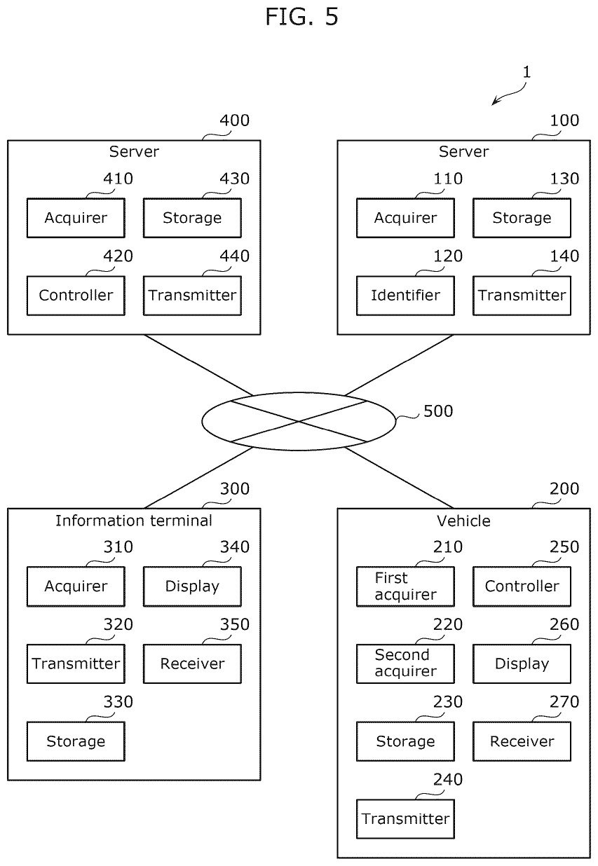

FIG. 5 is a diagram showing an example of the functional configuration of the authentication system in Embodiment 1.

Authentication system 1 includes servers 100 and 400, vehicle 200, and information terminal 300.

Server 100 includes acquirer 110, identifier 120, storage 130, and transmitter 140.

Acquirer 110 acquires information from vehicle 200, information terminal 300, or server 400. Acquirer 110 acquires the information by receiving the information via network 500.

Specifically, acquirer 110 acquires, from vehicle 200, the user information for identifying the user and the vehicle information for identifying vehicle 200. Acquirer 110 acquires, from server 400, response information which indicates a response to inquiry information for user authentication that is transmitted to server 400. Acquirer 110 may acquire, from vehicle 200, an initialization request which causes server 100 to initialize one or more functions that are enabled in vehicle 200.

Acquirer 110 is realized by, for example, communication IF 104.

Identifier 120 identifies, based on the user information, the vehicle information, and permission information which is previously stored, one or more functions that are performable by vehicle 200 and are permitted to be utilized by the user. The permission information includes one or more permission functions which are permitted to be utilized by the user identified by the user information and one or more functions which are performable by the vehicle identified by the vehicle information. Identifier 120 identifies, as the one or more functions described above, one or more common functions which are common to the one or more permission functions that are permitted to be utilized by the user and the one or more performable functions that are performable by vehicle 200. Identifier 120 is realized, for example, by processor 101, main memory 102, storage 103 and the like.

Storage 130 may store information acquired by acquirer 110. Specifically, storage 130 may store the user information, the vehicle information, the response information, the initialization request, and the like. Storage 130 may also store information generated by server 100. Specifically, storage 130 may store the inquiry information. Storage 130 may also store the permission information. Storage 130 is realized by, for example, storage 103.

Transmitter 140 transmits information to vehicle 200, information terminal 300, or server 400 via network 500. Specifically, transmitter 140 transmits function information indicating the one or more functions identified by identifier 120 to vehicle 200 via network 500. Transmitter 140 may transmit the inquiry information to server 400 via network 500. The inquiry information is information for inquiring whether to permit the user to utilize vehicle 200. In the utilization described above, the user who utilizes vehicle 200 is the user identified by the user information. In the utilization described above, vehicle 200 which is utilized is the vehicle identified by the vehicle information. When the response information acquired by acquirer 110 indicates that vehicle 200 is permitted to be utilized, transmitter 140 transmits, to vehicle 200, operation permission information for permitting vehicle 200 to perform the operation of vehicle 200. When the response information acquired by acquirer 110 indicates that vehicle 200 is not permitted to be utilized, transmitter 140 does not transmit, to vehicle 200, the operation permission information for permitting vehicle 200 to perform the operation of vehicle 200. Transmitter 140 is realized by, for example, communication IF 104.

Server 400 includes acquirer 410, controller 420, storage 430, and transmitter 440.

Acquirer 410 acquires information from server 100, vehicle 200, or information terminal 300. Acquirer 410 acquires the information by receiving the information via network 500. Specifically, acquirer 410 acquires, from information terminal 300, reservation information indicating a reservation for the utilization of vehicle 200 performed by the user. Acquirer 410 acquires setting completion information indicating completion of setting of the reservation for the utilization of vehicle 200. Acquirer 410 acquires the inquiry information from server 100. Acquirer 410 may acquire, from information terminal 300, return information indicating that vehicle 200 has been returned to a car sharing service provider. Acquirer 410 is realized by, for example, communication IF 104.

Controller 420 receives the reservation according to the reservation information acquired by acquirer 410. Specifically, based on the vehicle type and the scheduled period of utilization specified in the reservation information, vehicles of the vehicle type which have not been reserved for utilization during the scheduled period of utilization are identified based on reservation management information stored in storage 430. The reservation management information includes information indicating the status of utilization and the status of the reservation for each vehicle. In other words, the reservation management information is information in which, for each vehicle, the user information indicating the user who utilizes the vehicle or the user who is scheduled to utilize the vehicle is associated with a period during which the vehicle is utilized or a period during which the vehicle is scheduled to be utilized.

Controller 420 generates setting information of vehicle reservation for setting the vehicle which is identified by the reservation of utilization made by the user indicated by the user information included in the reservation information in the period during which the vehicle is scheduled to be utilized. Then, controller 420 causes transmitter 440 to transmit the generated setting information to vehicle 200 which has been identified. Controller 420 performs authentication processing according to the inquiry information acquired by acquirer 410. Specifically, controller 420 determines whether the user identified by the user information included in the acquired inquiry information is scheduled to utilize the vehicle identified by the vehicle information included in the inquiry information at the time when the inquiry information is acquired. When controller 420 determines that the vehicle is scheduled to be utilized at the time when the inquiry information is acquired, controller 420 generates the response information indicating that the vehicle is permitted to be utilized, and when controller 420 determines that the vehicle is not scheduled to be utilized at the time, controller 420 generates the response information indicating that the vehicle is not permitted to be utilized. Then, controller 420 causes transmitter 440 to transmit the generated response information to server 100.

Controller 420 is realized, for example, by processor 101, main memory 102, storage 103, and the like.

Storage 430 may store information acquired by acquirer 410. Specifically, storage 430 may store the reservation information, the setting completion information, the inquiry information, the return information, and the like. Storage 430 may also store information generated by server 400. Specifically, storage 430 may store the setting information for vehicle reservation. Storage 430 may also store user information, reservation management information, and the like registered in the car sharing service. Storage 430 is realized by, for example, storage 103.

Transmitter 440 transmits information to server 100, vehicle 200, or information terminal 300 via network 500. Specifically, transmitter 440 transmits the setting information of vehicle reservation to vehicle 200 via network 500. Transmitter 440 transmits, to vehicle 200, via network 500, reservation completion information indicating that the reservation for the vehicle has been received. Transmitter 440 transmits, to server 100, via network 500, the response information indicating a response to the inquiry information. When the return information has been acquired, transmitter 440 transmits utilization completion information indicating that the utilization performed by the user has been completed to vehicle 200 utilized by the user of information terminal 300 which has transmitted the return information. Transmitter 440 is realized by, for example, communication IF 104.

Vehicle 200 includes first acquirer 210, second acquirer 220, storage 230, transmitter 240, controller 250, display 260, and receiver 270.

First acquirer 210 acquires the user information for identifying the user. For example, first acquirer 210 repeatedly acquires the user information from a circuit that holds the user information by wirelessly communicating with the circuit. First acquirer 210 may acquire the user information from information terminal 300 by wirelessly communicating with information terminal 300 using a near field wireless communication technology such as Bluetooth or near field communication (NFC). In this case, the circuit is processor 301, main memory 302, storage 303, communication IF 304, and the like included in information terminal 300. The circuit is not limited to a circuit included in information terminal 300, and may be an NFC tag which is embedded in a card or another item. First acquirer 210 is realized by, for example, communication IF 206.

First acquirer 210 may acquire the user information from the user by biometric authentication, a one-time password, or the like.

Second acquirer 220 acquires information from server 100, server 400, or information terminal 300. Second acquirer 220 acquires the information by receiving the information via network 500. Specifically, second acquirer 220 acquires the function information from server 100. The function information indicates one or more functions which are identified based on the user information and the vehicle information, are performable by vehicle 200, and are permitted to be utilized by the user. Second acquirer 220 also acquires the setting information for vehicle reservation from server 400. Second acquirer 220 also acquires the operation permission information and the function information from server 100. Second acquirer 220 also acquires the utilization completion information from server 400. Second acquirer 220 is realized by, for example, TCU 201.

Storage 230 may store the information acquired by first acquirer 210 or second acquirer 220. Specifically, storage 230 may store the user information, the function information, the setting information, the operation permission information, the utilization completion information, and the like. Storage 230 may also store information generated in vehicle 200. Specifically, storage 230 may store the setting completion information, the initialization request, and the like. Storage 230 stores the vehicle information for identifying vehicle 200. Storage 230 is realized by, for example, storage 203.

Transmitter 240 transmits information to server 100, server 400, or information terminal 300 via network 500. Specifically, transmitter 240 transmits, to server 400, the setting completion information indicating that the setting of the reservation based on the setting information has been completed in vehicle 200. When the user information is acquired, transmitter 240 transmits, to server 100, the user information acquired by first acquirer 210 and the vehicle information stored in storage 230. When the utilization completion information is acquired, transmitter 240 transmits the initialization request to server 100. Transmitter 240 is realized by, for example, TCU 201.

Controller 250 enables the one or more functions indicated by the function information acquired by second acquirer 220. Controller 250 determines whether first acquirer 210 acquires information different from the user information acquired at the previous timing regarding the user information repeatedly acquired by first acquirer 210. When first acquirer 210 acquires information different from the user information acquired at the previous timing, controller 250 disables the one or more functions indicated by the function information. When first acquirer 210 acquires information different from the user information acquired at the previous timing a predetermined number of times, controller 250 may disable the one or more functions indicated by the function information. In other words, when first acquirer 210 acquires information different from the user information acquired at the previous timing less than a predetermined number of times, controller 250 may keep enabled the one or more functions indicated by the function information.

On the other hand, when first acquirer 210 acquires the same information as the user information acquired at the previous timing, controller 250 keeps enabled the one or more functions indicated by the function information. When controller 250 detects that the utilization of vehicle 200 performed by the user has been completed, controller 250 performs initialization for disabling the one or more functions indicated by the function information which have been enabled. The range of the initialization may be not complete but partial. In other words, controller 250 may disable, in a stepwise manner, the one or more functions enabled such that some of the functions are first disabled and then all the functions are finally disabled. The initialization may be to return the functions of vehicle 200 to a pre-shipment state, or may be to return the functions of vehicle 200 to a state set for vehicle 200.

Controller 250 may detect that the utilization of vehicle 200 performed by the user has been completed by acquiring the utilization completion information. Controller 250 may detect that the utilization of vehicle 200 performed by the user has been completed by detecting that the period of the reservation of vehicle 200 has been completed. Controller 250 may detect that the utilization of vehicle 200 performed by the user has been completed by detecting that the user information has not been acquired by first acquirer 210. Controller 250 may detect that the utilization of vehicle 200 performed by the user has been completed when first acquirer 210 acquires information different from the user information acquired at the previous timing regarding the user information repeatedly acquired by first acquirer 210.

Controller 250 is realized, for example, by a plurality of ECUs 202 and the like.

Display 260 displays the information acquired by first acquirer 210, the information acquired by second acquirer 220, the information generated by controller 250, and the like. Display 260 is realized by, for example, vehicle-mounted display 204.

Receiver 270 receives an input from the user. Receiver 270 is realized by, for example, input IF 205.

Information terminal 300 includes acquirer 310, transmitter 320, storage 330, display 340, and receiver 350.

Acquirer 310 acquires information from server 100, server 400, or vehicle 200. Acquirer 310 acquires the information by receiving the information via network 500. Specifically, acquirer 310 acquires the reservation completion information from server 400. Acquirer 310 is realized by, for example, communication IF 304.

Transmitter 320 transmits information to server 100, server 400, or vehicle 200 via network 500. Specifically, transmitter 320 transmits the reservation information to server 400. Transmitter 320 transmit the user information to vehicle 200. Transmitter 320 transmits the return information to server 400. Transmitter 320 by, is realized for example, communication IF 304.

Storage 330 may store the information acquired by acquirer 310. Specifically, storage 330 may store the reservation completion information. Storage 330 may also store the information generated by information terminal 300. Specifically, storage 330 may store the reservation information and the return information. Storage 330 may also store the user information. Storage 330 is realized by, for example, storage 303.

Display 340 displays the information acquired by acquirer 310, the generated information, and the like. Display 340 is realized by, for example, display 306.

Receiver 350 receives an input from the user. Receiver 350 receives, for example, an input related to the reservation of vehicle 200 from the user. Receiver 350 is realized by, for example, input device 305.

### Operation

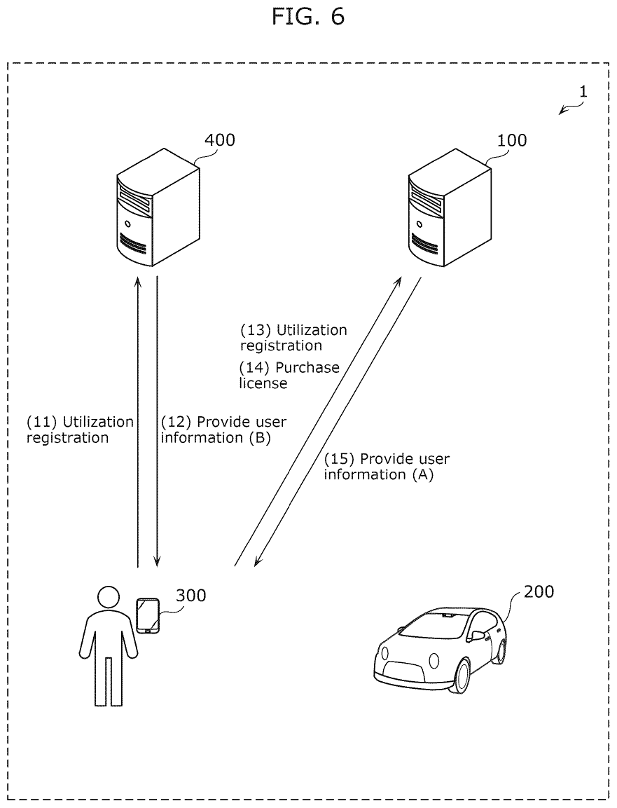

FIG. 6 is a diagram for illustrating registration processing for user information.

The user first uses information terminal 300 to perform utilization registration on server 400 which provides the car sharing service (11). In other words, information terminal 300 transmits, to server 400, personal information related to the user (such as the name of the user, the date of birth, an address, and a phone number).

Server 400 generates user information (B) based on the received personal information. User information (B) includes a user ID for identifying the user. The user ID is an ID which is used by server 400 to identify the user in the car sharing service. The user information may further include the personal information. Server 400 provides user information (B) to information terminal 300 (12). In other words, server 400 transmits generated user information (B) to information terminal 300. An item such as a card including a circuit which holds user information (B) may be issued to the user.

The user uses information terminal 300 to perform utilization registration on server 100 which provides a service for managing the functions of vehicle 200 that can be utilized by the user (13). In other words, information terminal 300 transmits, to server 100, the personal information related to the user (such as the name of the user, the date of birth, the address, and the phone number).

Server 400 generates user information (A) based on the received personal information. User information (A) includes a user ID for identifying the user. The user ID is an ID which is used by server 100 to identify the user in the service for managing the functions of vehicle 200. The user information may further include the personal information. Server 100 provides user information (A) indicated by (15) to information terminal 300. In other words, server 100 transmits generated user information (A) to information terminal 300.

The user uses information terminal 300 to purchase a license for an additional function of vehicle 200 (14). In other words, information terminal 300 transmits, to server 100, information indicating that the user has made a payment for the additional function. The user has made a payment, and thus server 100 generates permission information based on the information indicating that the user has made a payment. The permission information is information indicating whether each of a plurality of functions for each user is permitted to be utilized by a payment made by the user.

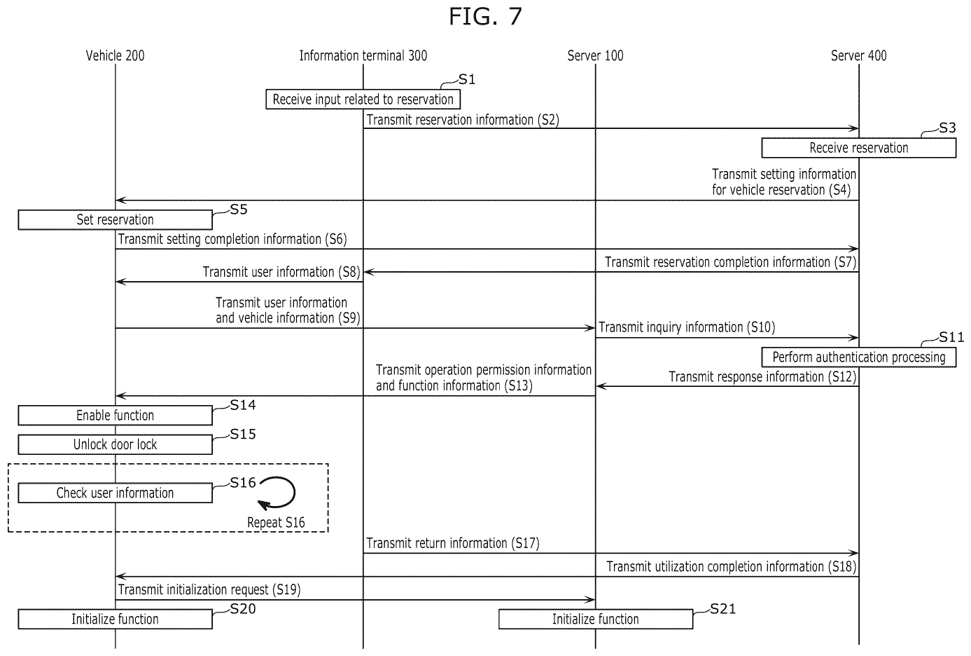

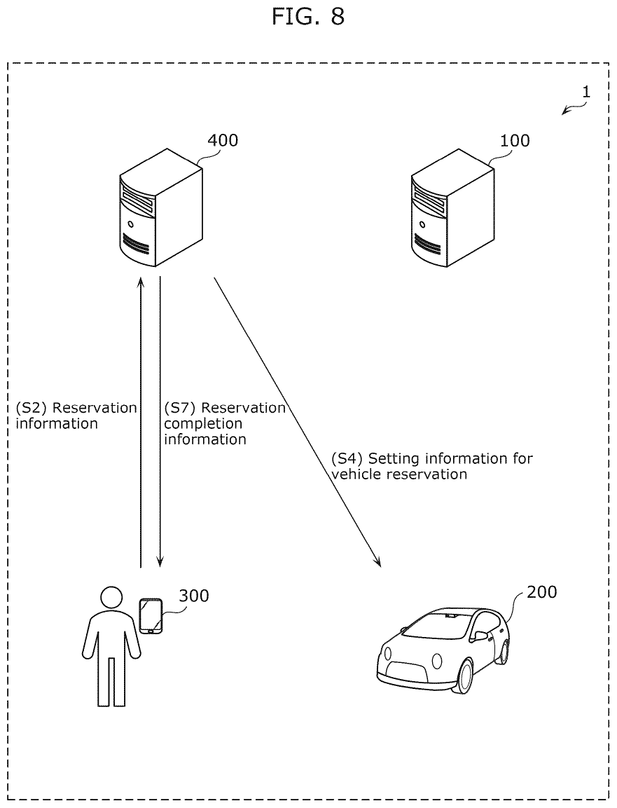

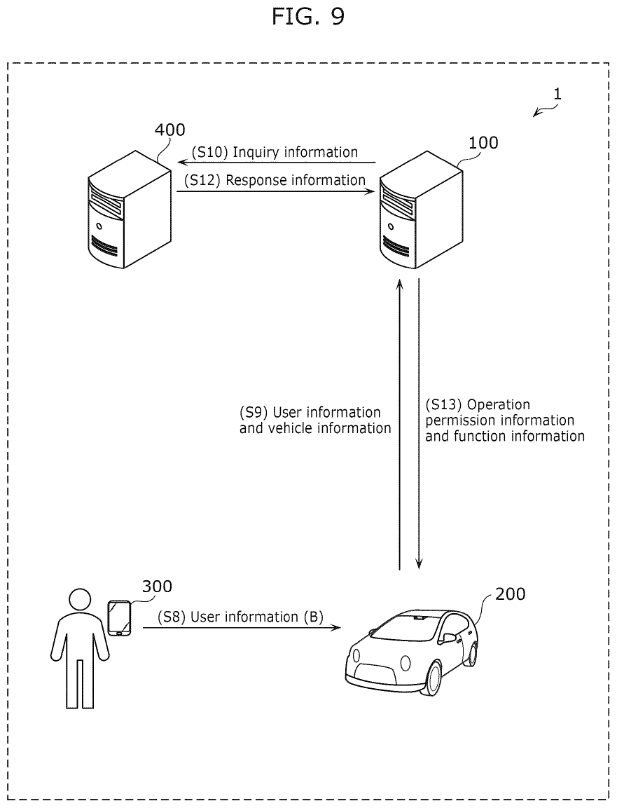

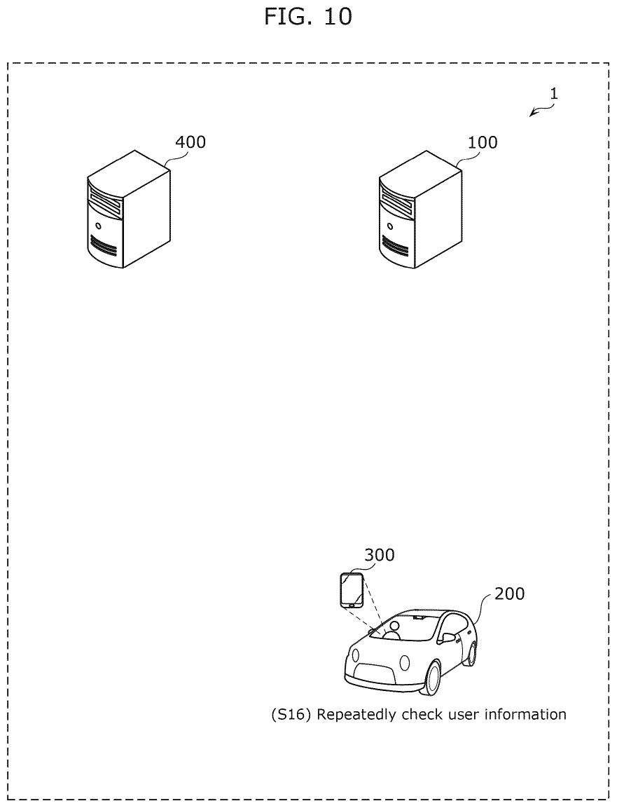

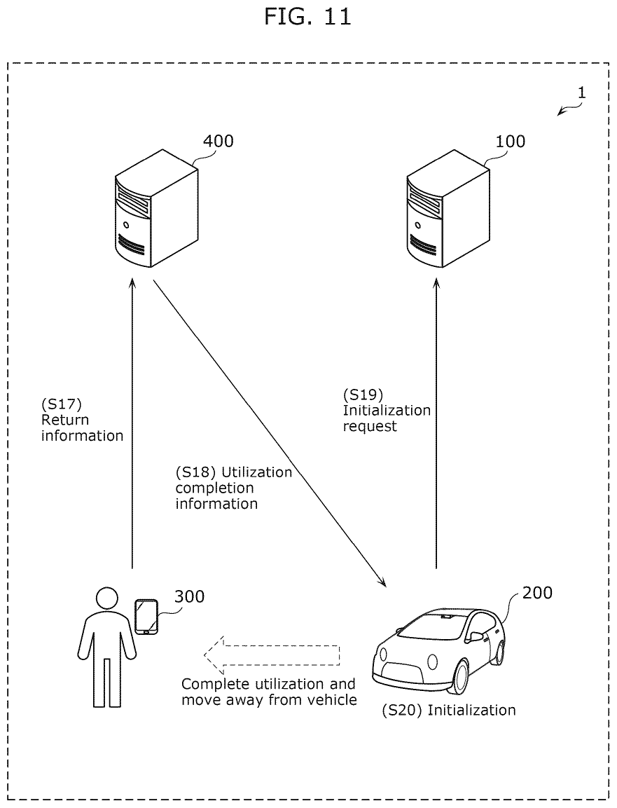

FIG. 7 is a sequence diagram showing an example of an authentication method performed by the authentication system in Embodiment 1. FIGS. 8 to 11 are diagrams for illustrating the flow of information in processing in the authentication method.

Information terminal 300 receives an input related to the reservation from the user (S1). Information terminal 300 generates the reservation information according to the received input. The reservation information includes the user information, the vehicle or the vehicle type which is the target of the reservation, the scheduled period of utilization, and the like.

Information terminal 300 transmits the reservation information to server 400 (S2).

When server 400 receives the reservation information, server 400 receives the reservation based on the reservation information (S3), and generates the setting information for vehicle reservation.

Server 400 transmits the generated setting information for vehicle reservation to vehicle 200 which is the target of the reservation (S4).

When vehicle 200 receives the setting information for vehicle reservation, vehicle 200 sets the reservation based on the setting information for vehicle reservation (S5). The setting information for vehicle reservation is information for which vehicle 200 permits the user to utilize vehicle 200 during the schedule period of the reservation based on the user information indicating the user who has made the reservation for vehicle 200.

When vehicle 200 completes the setting of the reservation, vehicle 200 transmits, to server 400, the setting completion information indicating that the setting of the reservation has been completed (S6).

When server 400 receives the setting completion information, server 400 transmits, to information terminal 300, the reservation completion information indicating that the reservation for vehicle 200 has been completed (S7). The reservation completion information includes information related to vehicle 200 which is the target of the reservation.

When information terminal 300 receives the reservation completion information, information terminal 300 presents the reservation completion information to the user. Hence, in order to utilize vehicle 200 which is the target of the reservation, the user thereafter brings, for example, information terminal 300 closer to vehicle 200. In this way, wireless communication is performed between information terminal 300 and vehicle 200, and information terminal 300 transmits the user information to vehicle 200 (S8).

When vehicle 200 receives the user information, vehicle 200 transmits the user information and the vehicle information to server 100 (S9).

When server 100 receives the user information and the vehicle information, server 100 transmits the inquiry information for user authentication to server 400 (S10).

When server 400 receives the inquiry information, server 400 performs the authentication processing (S11). Server 400 generates the response information including the result of authentication performed in the authentication processing.

Server 400 transmits the generated response information to server 100 (S12).

When the received response information indicates that vehicle 200 is permitted to be utilized, server 100 transmits, to vehicle 200, the operation permission information for permitting vehicle 200 to perform the operation of vehicle 200 and the function information (S13).

Vehicle 200 enables one or more functions indicated by the function information based on the received function information (S14), and unlocks the door lock of vehicle 200 based on the received operation permission information (S15). Step S14 may be performed during step S5.

Vehicle 200 receives the user information from information terminal 300, and repeats processing for checking the user information which is repeatedly received (S16).

When information terminal 300 receives, from the user, an input indicating that the utilization of vehicle 200 has been completed, information terminal 300 transmits the return information to server 400 (S17).

When server 400 receives the return information, server 400 transmits the utilization completion information to vehicle 200 (S18).

When vehicle 200 receives the utilization completion information, vehicle 200 transmits, to server 100, the initialization request for initializing information stored in server 100 and related to the enabled function (S19), and then initializes the function enabled in vehicle 200 (S20). The order of the processing in step S19 and the processing in step S20 may be reversed. When vehicle 200 detects that the utilization of vehicle 200 performed by the user has been completed, vehicle 200 may initialize the enabled function. Vehicle 200 may detect that the utilization of vehicle 200 performed by the user has been completed, for example, by receiving the utilization completion information from server 400, or may detect that the utilization of vehicle 200 performed by the user has been completed by detecting that information terminal 300 has been moved away from vehicle 200.

When server 100 receives the initialization request, server 100 initializes the enabled function (S21).

### Effects and Like

An authentication method according to the present embodiment is an authentication method performed by a system including server 100 and vehicle 200 that is communicatively connected to server 100 via network 500. In the authentication method, vehicle 200 acquires user information for identifying a user. Vehicle 200 acquires vehicle information for identifying vehicle 200. Vehicle 200 transmits the user information acquired and the vehicle information acquired to server 100. Vehicle 200 acquires, from server 100, function information indicating one or more functions that are identified based on the user information and the vehicle information, are performable by vehicle 200, and are permitted to be utilized by the user. Vehicle 200 enables the one or more functions indicated by the function information.

In this way, since the function information indicating the one or more functions that are identified based on the user information and the vehicle information, are performable by vehicle 200, and are permitted to be utilized by the user is enabled, only the user who has made a payment can utilize an additional function regardless of the vehicle.

In the authentication method according to the present embodiment, server 100 acquires the user information and the vehicle information from vehicle 200. Server 100 identifies the one or more functions based on the user information, the vehicle information, and permission information that is previously stored. Server 100 transmits, to vehicle 200, the function information indicating the one or more functions identified.

Hence, it is possible to appropriately identify the one or more functions which can be utilized by the user.

In the authentication method according to the present embodiment, the permission information includes: one or more permission functions that are permitted to be utilized by the user identified by the user information; and one or more performable functions that are performable by the vehicle identified by the vehicle information. In the identifying, server 100 identifies, as the one or more functions, one or more common functions that are common to the one or more permission functions and the one or more performable functions.

Hence, it is possible to appropriately identify the one or more functions which are performable by vehicle 200 and are permitted to be utilized by the user.

In the authentication method according to the present embodiment, vehicle 200 receives operation permission information for permitting vehicle 200 to perform an operation of vehicle 200 to transition to a state where the operation of vehicle 200 is performable. Server 100 transmits, to other server 400, inquiry information for inquiring whether the user identified by the user information is previously permitted to utilize vehicle 200 identified by the vehicle information when the user information and the vehicle information are acquired from vehicle 200. Server 100 receives, from other server 400, response information indicating a response to the inquiry information. Server 100 prevents the transmission of the operation permission information to vehicle 200 when the response information indicates that vehicle 200 is not permitted to be utilized.

Hence, user authentication for the utilization of the vehicle performed by the user can be performed by other server 400.

### Variation

Although in Embodiment 1, an example where server 400 acquires the return information from information terminal 300 is described, server 100 may acquire the return information from information terminal 300. In this case, the return information acquired by server 100 may be transmitted to server 400. Server 400 may acquire the return information from information terminal 300 via server 100.

Acquirer 110 of server 100 acquires, from information terminal 300, the return information indicating that vehicle 200 has been returned. Storage 130 further stores the return information. When the return information is acquired, transmitter 140 transmits the utilization completion information indicating that the utilization performed by the user has been completed to vehicle 200 utilized by the user of information terminal 300 which has transmitted the return information. Transmitter 140 also transmits the return information to server 400. When transmitter 140 transmits the return information to server 400, transmitter 140 does not need to transmit the utilization completion information to vehicle 200 utilized by the user of information terminal 300 which has transmitted the return information, and transmitter 440 of server 400 may transmit the utilization completion information to vehicle 200.

### Embodiment 2

### Configuration

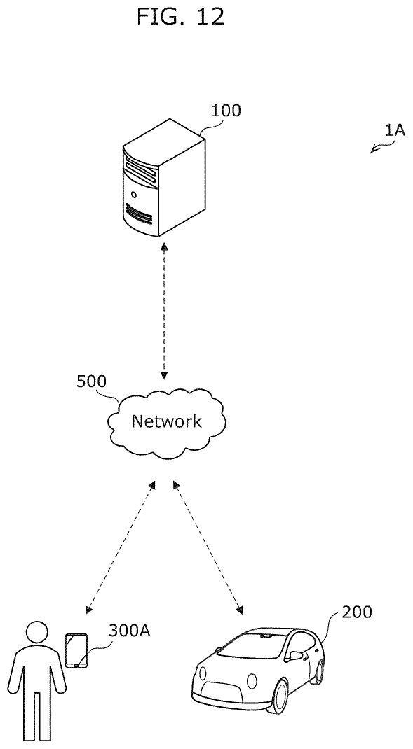

FIG. 12 is a diagram for illustrating an outline of an authentication system in Embodiment 2.

Specifically, FIG. 12 shows server 100, vehicle 200, information terminal 300A, and network 500. For example, authentication system 1A includes, among these constituent elements, server 100, vehicle 200, and information terminal 300A. Server 100 is a server for managing the functions of vehicle 200 which can be utilized by a user. For example, vehicle 200 is a vehicle which is shared with family members, friends, and the like. Information terminal 300A is a terminal which is possessed by the user.

Server 100, vehicle 200, and information terminal 300A are communicatively connected via network 500. Information terminal 300A may be communicatively connected to network 500 via an unillustrated wireless LAN router, or may be communicatively connected to network 500 by communicating with a base station on a mobile phone communication line.

Authentication system 1A is a system which manages an additional function that the user can utilize by making a payment, and permits only the user who has made a payment to utilize the additional function regardless of the vehicle. While authentication system 1 in Embodiment 1 is a system which manages the functions of vehicle 200 utilized in a car sharing service, authentication system 1A in Embodiment 2 is a system which manages the functions of vehicle 200 that is utilized by being shared with family members, friends, and the like. Hence, authentication system 1A differs from authentication system 1 in that authentication system 1A does not include server 400.

In authentication system 1A, server 100 associates one or more permission functions which are functions of the vehicle that are permitted to be utilized by the user with user information for identifying the user, and stores them. The one or more permission functions include the additional function which the user can utilize by making a payment. Server 100 associates vehicle information for identifying the vehicle with one or more performable functions which are performable by the vehicle, and stores them.

The user information managed by server 100 may include destination information for transmitting information to information terminal 300A possessed by the user identified by the user information. The vehicle information managed by server 100 may include destination information for transmitting information to vehicle 200 identified by the vehicle information.

Server 100 manages the information as described above to be able to associate the user or information terminal 300A possessed by the user with vehicle 200 utilized by the user. Server 100 can transmit information for the user to information terminal 300A or vehicle 200.

The hardware configurations of server 100, vehicle 200, and information terminal 300A are the same as those of server 100, vehicle 200, and information terminal 300 in Embodiment 1, and thus description thereof is omitted.

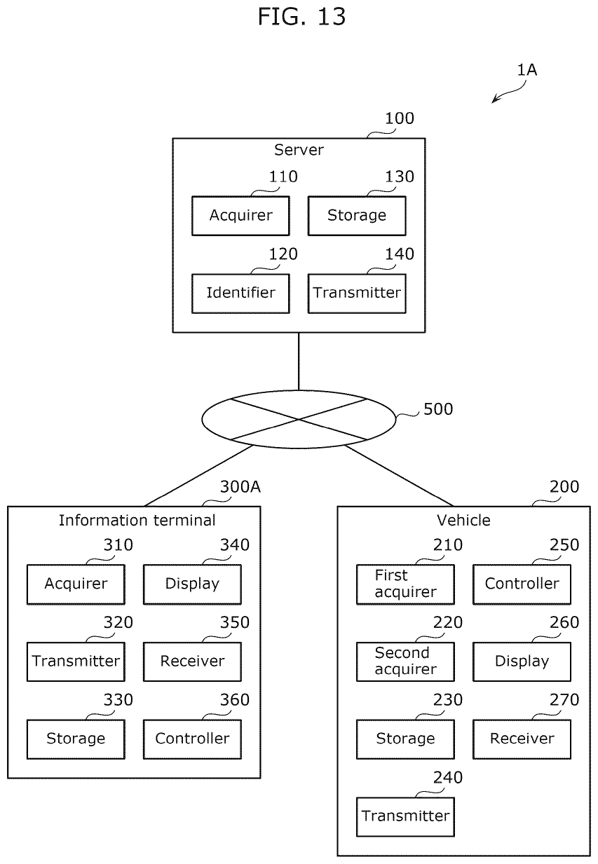

FIG. 13 is a diagram showing an example of the functional configuration of the authentication system in Embodiment 2.

Authentication system 1A includes server 100, vehicle 200, and information terminal 300A.

Embodiment 2 differs from Embodiment 1 in that server 100 is operated instead of server 400 such that authentication processing is performed in information terminal 300A. Information terminal 300A includes, in addition to the functional configuration of information terminal 300, controller 360 for performing the authentication processing.

The differences will be specifically described.

Server 100 transmits inquiry information to information terminal 300A. In other words, transmitter 140 transmits the inquiry information to information terminal 300A via network 500. The inquiry information is information for inquiring whether to permit the user to utilize vehicle 200.

Then, information terminal 300A generates response information to the inquiry information, and transmits the generated response information to server 100. Controller 360 included in information terminal 300A displays, on display 340, an UI for receiving an input as to whether the user utilizes, in vehicle 200, an additional function that the user can utilize by making a payment, and when receiver 350 receives, from the user, a positive response to the utilization of vehicle 200, controller 360 generates the response information indicating that vehicle 200 is permitted to be utilized. When receiver 350 receives, from the user, a negative response to the utilization of vehicle 200, controller 360 generates the response information indicating that vehicle 200 is not permitted to be utilized. Controller 360 causes transmitter 320 to transmit the generated response information to server 100.

When server 100 issues authentication data for utilizing vehicle 200 to information terminal 300A, server 100 may skip the authentication processing for the user indicated by the user information transmitted by vehicle 200. In other words, in this case, server 100 does not need to transmit the inquiry information to information terminal 300A to receive the response information. Server 100 may periodically perform the authentication processing with information terminal 300A to update the authentication data.

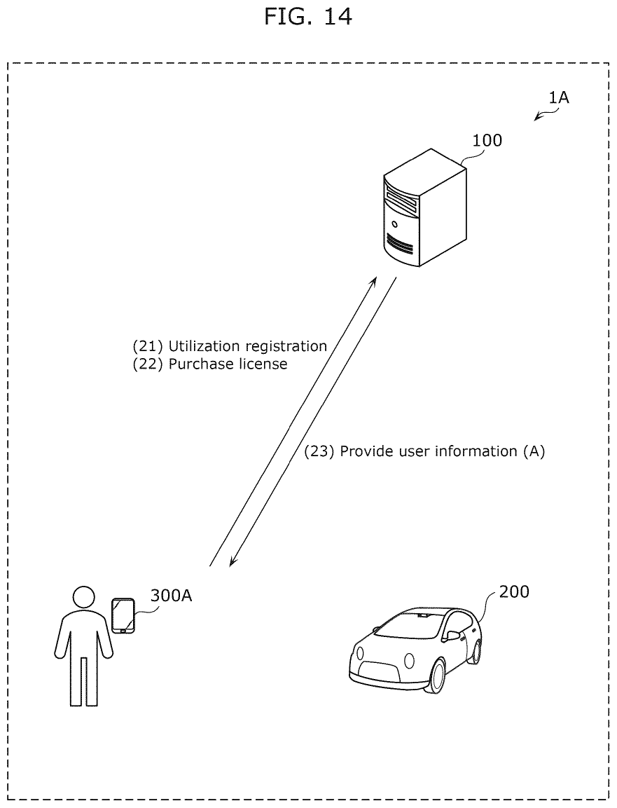

FIG. 14 is a diagram for illustrating registration processing for user information.

The user first uses information terminal 300A to perform utilization registration on server 100 which provides a service for managing the functions of vehicle 200 that can be utilized by the user (21). In other words, information terminal 300A transmits, to server 100, personal information related to the user (such as the name of the user, the date of birth, an address, and a phone number).

Server 100 generates user information (A) based on the received personal information. User information (A) includes a user ID for identifying the user. The user ID is an ID which is used by server 100 to identify the user in the service for managing the functions of vehicle 200. The user information may further include the personal information. Server 100 provides user information (A) indicated by (23) to information terminal 300A. In other words, server 400 transmits generated user information (A) to information terminal 300A.

The user uses information terminal 300A to purchase a license for an additional function of vehicle 200 (22). In other words, information terminal 300A transmits, to server 100, information indicating that the user has made a payment for the additional function. The user has made a payment, and thus server 100 generates permission information based on the information indicating that the user has made a payment. The permission information is information indicating whether each of a plurality of functions for each user is permitted to be utilized by a payment made by the user.

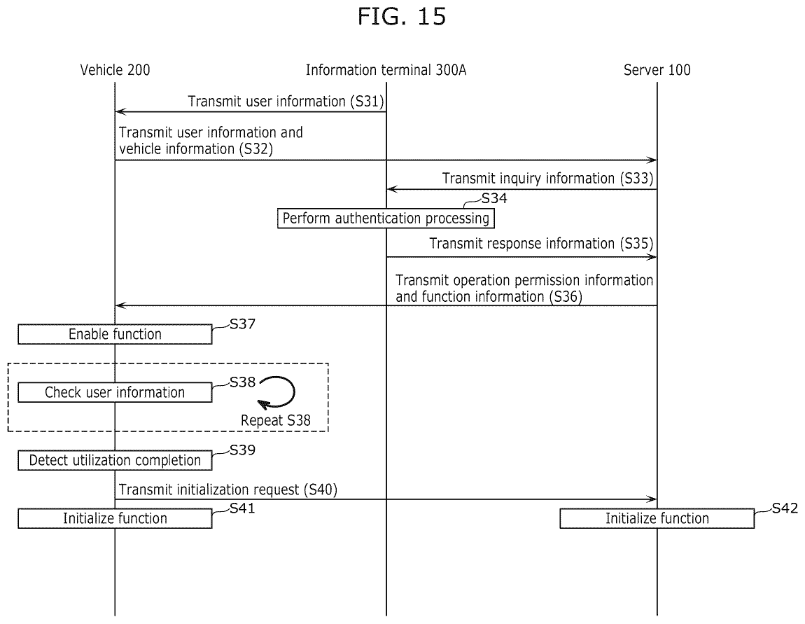

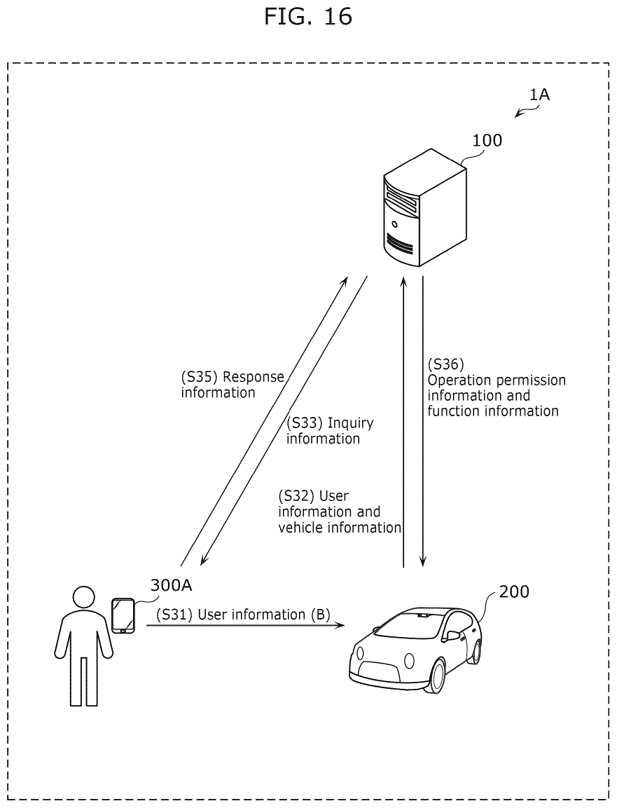

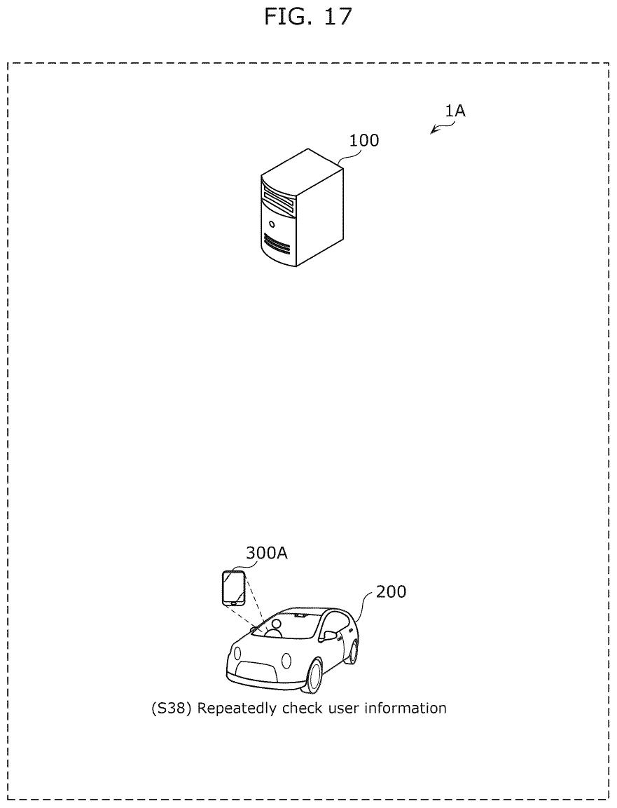

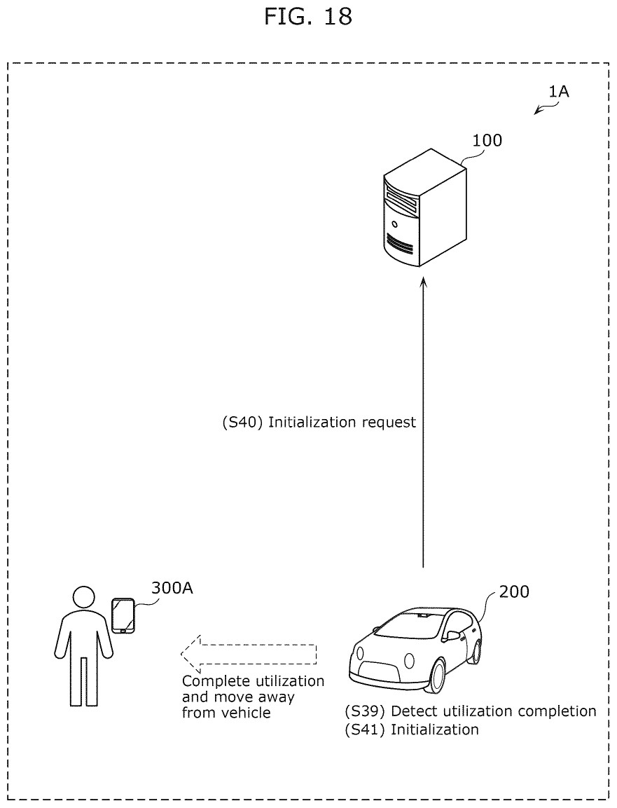

FIG. 15 is a sequence diagram showing an example of an authentication method performed by the authentication system in Embodiment 2. FIGS. 16 to 18 are diagrams for illustrating the flow of information in processing in the authentication method.

In order to utilize vehicle 200, the user brings, for example, information terminal 300A closer to vehicle 200. In this way, wireless communication is performed between information terminal 300A and vehicle 200, and information terminal 300A transmits the user information to vehicle 200 (S31).

When vehicle 200 receives the user information, vehicle 200 transmits the user information and the vehicle information to server 100 (S32).

When server 100 receives the user information and the vehicle information, server 100 transmits the inquiry information for user authentication to information terminal 300A (S33).

When information terminal 300A receives the inquiry information, information terminal 300A performs the authentication processing (S34). Information terminal 300A generates the response information including the result of authentication performed in the authentication processing. In the authentication processing, information terminal 300A displays an UI for receiving an input as to whether the user utilizes, in vehicle 200, the additional function that the user can utilize by making a payment, and when information terminal 300A receives, from the user, a positive response to the utilization of vehicle 200, information terminal 300A generates the response information indicating that vehicle 200 is permitted to be utilized. When information terminal 300A receives, from the user, a negative response to the utilization of vehicle 200, information terminal 300A generates the response information indicating that vehicle 200 is not permitted to be utilized.

Information terminal 300A transmits the generated response information to server 100 (S35).

When the received response information indicates that vehicle 200 is permitted to be utilized, server 100 transmits, to vehicle 200, the operation permission information for permitting vehicle 200 to perform the operation of vehicle 200 and the function information (S36).

Vehicle 200 enables one or more functions indicated by the function information based on the received function information (S37).

Vehicle 200 receives the user information from information terminal 300A, and repeats processing for checking the user information which is repeatedly received (S38).

When vehicle 200 detects that the utilization of vehicle 200 performed by the user has been completed (S39), vehicle 200 transmits, to server 100, the initialization request for initializing information related to the enabled function stored in server 100 (S40), and then initializes the function enabled in vehicle 200 (S41). The order of the processing in step S40 and the processing in step S41 may be reversed. Vehicle 200 may detect that the utilization of vehicle 200 performed by the user has been completed by detecting that information terminal 300A has been moved away from vehicle 200.

When server 100 receives the initialization request, server 100 initializes the enabled function (S42).

### Effects and Like

In the authentication method according to the present embodiment, vehicle 200 receives operation permission information for permitting vehicle 200 to perform an operation of vehicle 200 to transition to a state where the operation is performable. Server 100 transmits, to information terminal 300A possessed by the user, inquiry information for inquiring whether to permit the user identified by the user information to utilize vehicle 200 identified by the vehicle information when the user information and the vehicle information are acquired from vehicle 200. Server 100 acquires, from information terminal 300A, response information indicating a response to the inquiry information. Server 100 prevents the transmission of the operation permission information when the response information indicates that vehicle 200 is not permitted to be utilized.

Hence, user authentication for the utilization of vehicle 200 performed by the user can be performed by information terminal 300A.

### Others

In each of the embodiments described above, constituent elements may be formed by dedicated hardware or may be realized by executing software programs suitable for the constituent elements. A program executor such as a CPU or a processor may read and execute software programs recorded in a recording medium such as a hard disk or a semiconductor memory to realize the constituent elements. Here, software for realizing the authentication system and the like in each of the embodiments described above is programs for causing a computer to execute the steps included in the flowcharts shown in the figures.

The following cases are also included in the present disclosure.

(1) Each of the devices described above is specifically a computer system which includes a microprocessor, a ROM, a RAM, a hard disk unit, a display unit, a keyboard, a mouse, and the like. In the RAM or the hard disk unit, computer programs are stored. The microprocessor is operated according to the computer programs, and thus each of the devices achieves its functions. Here, the computer programs are a combination of a plurality of instruction codes which indicate commands to a computer in order to achieve predetermined functions.

(2) A part or all of the constituent elements of each of the devices described above may be formed with one system large scale integration (LSI) circuit. The system LSI circuit is an ultra-multifunctional LSI circuit manufactured by integrating a plurality of components on a single chip, and is specifically a computer system which includes a microprocessor, a ROM, a RAM, and the like. In the RAM, computer programs are stored. The microprocessor is operated according to the computer programs, and thus the system LSI circuit achieves its functions.

(3) A part or all of the constituent elements of each of the devices described above may be formed with an IC card or a single module which is detachable with respect to the device. The IC card or the module is a computer system which includes a microprocessor, a ROM, a RAM, and the like. The IC card or the module may include the ultra-multifunctional LSI circuit described above. The microprocessor is operated according to computer programs, and thus the IC card or the module achieves its functions. The IC card or the module may be tamper-resistant.

(4) The present disclosure may be the methods described above. The present disclosure may be computer programs which cause a computer to realize these methods, or may be digital signals formed with the computer programs.

The present disclosure may be a computer-readable recording medium having recorded thereon the computer programs or the digital signals. Examples of the computer-readable recording medium include a flexible disk, a hard disk, a CD-ROM, an MO, a DVD, a DVD-ROM, a DVD-RAM, a Blu-ray (registered trademark) disc (BD), a semiconductor memory, and the like. The present disclosure may be the digital signals recorded in each of these recording media.

The present disclosure may be the computer programs or the digital signals which are transmitted via a telecommunication line, a wireless or wired communication line, a network such as the Internet, data broadcasting, or the like.

The present disclosure may be a computer system which includes a microprocessor and a memory. In the computer system, the memory may store the computer programs, and the microprocessor may be operated according to the computer programs.

By recording and transferring the programs or the digital signals, or by transferring the programs or the digital signals via the network or the like, the programs or the digital signals may be operated by another independent computer system.

(5) The embodiments and the variations described above may be combined.

While various embodiments have been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims are incorporated herein by reference in their entirety: Japanese Patent Application No. 2024-038117 filed on Mar. 12, 2024.

### INDUSTRIAL APPLICABILITY

The present disclosure is useful as a vehicle or the like in which only a user who has made a payment can utilize an additional function regardless of the vehicle.

1 A vehicle that is communicatively connected to a server via a network, the vehicle comprising:
a processor; and
a non-transitory memory that stores a program,
wherein the processor executes the program to cause the vehicle to operate as:
a first acquirer that acquires user information for identifying a user;
a storage that stores vehicle information for identifying the vehicle;
a transmitter that transmits the user information acquired and the vehicle information stored in the storage to the server;
a second acquirer that acquires, from the server, function information indicating one or more functions that:
are identified based on the user information and the vehicle information;
are performable by the vehicle; and
are permitted to be utilized by the user; and
a controller that enables the one or more functions indicated by the function information.

2. The vehicle according to claim 1,
wherein the first acquirer repeatedly acquires the user information from a circuit that holds the user information by wirelessly communicating with the circuit, and
when the first acquirer acquires information different from the user information acquired at a previous timing, the controller disables the one or more functions.

3. The vehicle according to claim 2,
wherein when the first acquirer acquires same information as the user information acquired at the previous timing, the controller keeps the one or more functions enabled.

4. An authentication method performed by an authentication system including a server and a vehicle that is communicatively connected to the server via a network, the authentication method comprising:
acquiring, by the vehicle, user information for identifying a user;
acquiring, by the vehicle, vehicle information for identifying the vehicle;
transmitting, by the vehicle, the user information acquired and the vehicle information acquired to the server;
acquiring, by the vehicle, from the server, function information indicating one or more functions that:
are identified based on the user information and the vehicle information;
are performable by the vehicle; and
are permitted to be utilized by the user; and
enabling, by the vehicle, the one or more functions indicated by the function information.

5. The authentication method according to claim 4, further comprising:
acquiring, by the server, the user information and the vehicle information from the vehicle;
identifying, by the server, the one or more functions based on the user information, the vehicle information, and permission information that is previously stored; and
transmitting, by the server, to the vehicle, the function information indicating the one or more functions identified.

6. The authentication method according to claim 5,
wherein the permission information includes:
one or more permission functions that are permitted to be utilized by the user identified by the user information; and
one or more performable functions that are performable by the vehicle identified by the vehicle information, and
in the identifying, the server identifies, as the one or more functions, one or more common functions that are common to the one or more permission functions and the one or more performable functions.

7. The authentication method according to claim 4, further comprising:
transitioning to a state where an operation of the vehicle is performable, by receiving, by the vehicle, operation permission information for permitting the operation;
transmitting, by the server, to an information terminal possessed by the user, inquiry information for inquiring whether to permit the user identified by the user information to utilize the vehicle identified by the vehicle information when the user information and the vehicle information are acquired from the vehicle;
acquiring, by the server, from the information terminal, response information indicating a response to the inquiry information; and
preventing, by the server, transmission of the operation permission information when the response information indicates that the vehicle is not permitted to be utilized.

8. The authentication method according to claim 4, further comprising:
transitioning to a state where an operation of the vehicle is performable, by receiving, by the vehicle, operation permission information for permitting the vehicle to perform the operation;
transmitting, by the server, to an other server, inquiry information for inquiring whether the user identified by the user information is previously permitted to utilize the vehicle identified by the vehicle information when the user information and the vehicle information are acquired from the vehicle;
receiving, by the server, from the other server, response information indicating a response to the inquiry information; and
preventing, by the server, transmission of the operation permission information to the vehicle when the response information indicates that the vehicle is not permitted to be utilized.
